(19) United States
(12) Patent Application Publication
(10) Pub. No.: US 2026/0278145 A1
(43) Pub. Date: Sep. 17, 2026

(54) AUTOMATIC FILTER BINDING FOR ROW-LEVEL SECURITY IN DATABASE SYSTEMS

(71) Applicant: SAP SE, Walldorf (DE)

(72) Inventors: Yanchen Cao, Xi'an (CN); Yinghua Ouyang, Xi'an (CN); Xun Zhang, Xi'an (CN); Boyang Zhang, Xi'an (CN); Zhen Tian, Xi'an (CN)

(21) Appl. No.: 19/080,997

(22) Filed: Mar. 17, 2025

(51) Int. Cl. G06F 21/62; G06F 16/2452

(52) U.S. Cl. CPC G06F 21/6227; G06F 16/24524

(57) ABSTRACT

Methods, systems, and computer-readable storage media for providing an initial query tree responsive to a query, the initial query tree including a set of view nodes, determining a sub-set of view nodes from the set of view nodes, each view node in the sub-set of view nodes being included in the sub-set of view nodes in response to metadata indicating that row-level security is to be applied, for a first view node in the sub-set of view nodes, identifying a first condition provider procedure that is to be executed, determining that the first condition provider procedure comprises a first set of input parameters comprising predefined input parameters, and in response, executing the first condition provider procedure using values for the first set of input parameters provided for the first view node to provide a first filter string, and inserting the first filter string into the initial query tree.

### BACKGROUND

Database systems store data that can be queried. For example, a query can be submitted to a database system, which processes the query and provides a result. Queries are submitted in a query language. An example query language includes, without limitation, the structured query language (SQL), which can be described as a standard database language that is used to create, maintain and retrieve data stored in a relational database (e.g., a database, in which data is stored in relational tables). Access to data can be restricted. For example, users and/or applications can have access to some data and may be denied access to other data. In querying a database system, data should only be visible to a source of the query (e.g., a user and/or an application querying a database system) that is authorized to access the data.

### SUMMARY

Implementations of the present disclosure are directed to providing row-level security in databases systems. More particularly, implementations of the present disclosure are directed to automatic filter binding in processing queries to enforce row-level security in database systems.

In some implementations, actions include providing an initial query tree responsive to a query for querying a database system, the initial query tree including a set of view nodes, determining a sub-set of view nodes from the set of view nodes, each view node in the sub-set of view nodes being included in the sub-set of view nodes in response to metadata indicating that row-level security is to be applied, for a first view node in the sub-set of view nodes, identifying a first condition provider procedure that is to be executed, determining that the first condition provider procedure comprises a first set of input parameters comprising predefined input parameters, and in response, executing the first condition provider procedure using values for the first set of input parameters provided for the first view node to provide a first filter string, and inserting the first filter string into the initial query tree, providing a final query tree including the initial query tree and inserted filter strings, generating a query execution plan, executing, by an execution engine, the query execution plan to query a database and generate results responsive to the query, and returning the results. Other implementations of this aspect include corresponding systems, apparatus, and computer programs, configured to perform the actions of the methods, encoded on computer storage devices.

These and other implementations can each optionally include one or more of the following features: the first filter string is determined by the first condition provider procedure from a permission table; the permission table defines a set of filter strings that are to be applied to respective views of view nodes; providing a final query tree including the initial query tree and inserted filter strings includes converting the first filter string to a filter predicate and injecting the filter predicate into the initial query tree; the filter predicate is a WHERE predicate; the predefined input parameters are a schema name and an object name; and operations further comprise for a second view node in the sub-set of view nodes, identifying a second condition provider procedure that is to be executed, determining that the second condition provider procedure includes a second set of input parameters that is absent the predefined input parameters, and in response, executing the second condition provider procedure to provide a second filter string based on an identifier of a user that submitted the query, and inserting the second filter string into the initial query tree.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts a conceptual architecture for instituting row-level security in database systems in accordance with implementations of the present disclosure.

FIGS. 3A and 3B depict example processes that can be executed in accordance with implementations of the present disclosure.

FIG. 4 is a schematic illustration of example computer systems that can be used to execute implementations of the present disclosure.

Like reference symbols in the various drawings indicate like elements.

### DETAILED DESCRIPTION

Implementations of the present disclosure are directed to providing row-level security in databases systems. More particularly, implementations of the present disclosure are directed to automatic filter binding in processing queries to enforce row-level security in database systems.

Implementations can include actions of providing an initial query tree responsive to a query for querying a database system, the initial query tree including a set of view nodes, determining a sub-set of view nodes from the set of view nodes, each view node in the sub-set of view nodes being included in the sub-set of view nodes in response to metadata indicating that row-level security is to be applied, for a first view node in the sub-set of view nodes, identifying a first condition provider procedure that is to be executed, determining that the first condition provider procedure comprises a first set of input parameters comprising predefined input parameters, and in response, executing the first condition provider procedure using values for the first set of input parameters provided for the first view node to provide a first filter string, and inserting the first filter string into the initial query tree, providing a final query tree including the initial query tree and inserted filter strings, generating a query execution plan, executing, by an execution engine, the query execution plan to query a database and generate results responsive to the query, and returning the results.

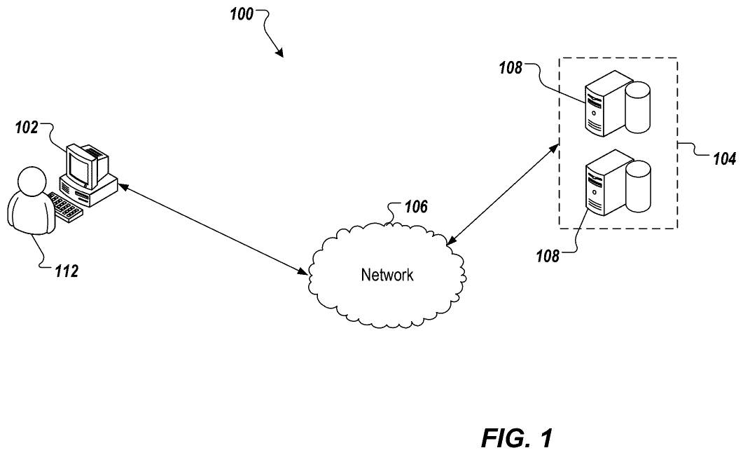

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can host a database system that stores data in tables. In some examples, the database system receives a query (e.g., from a user, from an application) that includes query authorization data (e.g., user role data, user group data). For example, the user 112 can submit a query to the database system through the client device 102. In some examples, the query includes query authorization data, such as user role data and/or user group data. For example, the user 112 can be logged into the database system and be associated with user profile data, which includes the query authorization data. As described in further detail herein, users, such as the user 112, are associated with privilege levels that enable access to certain data and prohibit access to certain data at a row level.

To provide context for implementations of the present disclosure, and as introduced above, database systems store data that can be queried. Increasingly, database systems store massive amounts of data as data warehousing, big data, and Internet-Of-Things (IoT), for example, progress. In some database systems, data is stored in tables that include rows, each row representing a record, and columns, each column representing a field of a record. In some examples, a query can be submitted to a database system, which processes the query and provides a result. Queries are submitted in a query language. An example query language includes, without limitation, the structured query language (SQL), which can be described as a standard database language that is used to create, maintain and retrieve data stored in a relational database (e.g., a database, in which data is stored in relational tables).

Access to data can be restricted. That is, for example, security can be applied to data, such that only authorized users are able to access the data. This can be referred to as access control. For example, users and/or applications can have access to some data and may be denied access to other data. In querying a database system, data should only be visible to a source of the query (e.g., a user and/or an application querying a database system) that is authorized to access the data.

One concept in providing multi-level and fine granular access control is row-level security, which applies access control to records by row. More particularly, row-level security enables different users to access different portions of data in the same database object. As a non-limiting example, while sales data for all regions are contained within a view, regional sales managers (e.g., a defined role) are only allowed to see the data for their respective region. In the context of row-level security, one or more filters are generated for users at runtime based on records read from a permission table. For example, the permission table can define what data is accessible based on roles. The one or more filters are applied to database objects for respective users, such that results (responsive to queries) only contain data that the respective user is allowed to view. In this manner, different users (having different roles) will see different portions of data in the same database object.

However, traditional row-level security suffers from disadvantages. For example, traditional row-level security does not support automatic filter binding. As such, in order to distinguish filter generation for different views, users have to define dedicated condition providers for each view. As a result, traditional row-level security injects a level of complexity (e.g., defining dedicated condition providers for each view), which not only expends technical resources, but also reduces query performance in applying row-level security during query processing. That is, queries can take longer and expend more technical resources (e.g., processing, memory) than desired. Such performance degradation is compounded in querying against relatively large tables using row-level security.

In view of the above context, implementations of the present disclosure provide time- and resource-efficient row-level security for database systems. As described in further detail herein, implementations of the present disclosure provide automatic filter binding for row-level security in querying database systems. In some implementations, one or more database objects that are to be protected by row-level security are defined. Example database objects include views (e.g., SQL views) on data stored in a database system. A view can be described as a virtual table that presents data from one or more tables in a structured format. In some implementations, a permission table is provided and stores schemas, view names, and filter names to be applied to each view. In accordance with implementations of the present disclosure, filter strings are selectively inserted into query trees based on input parameters to a condition provider procedure and a permission table to filter results returned in response to queries.

To provide additional context for implementations of the present disclosure, a high-level discussion of query processing is provided. More particularly, and as introduced above, database systems store data in tables and enable queries to be executed to provide query results that can include, for example, one or more views on the data stored in the tables. Among other operations, queries can join, project, and aggregate data stored in tables using relational operators to provide query results. In some instances, the data models and queries can implicate hundreds, if not thousands of database tables and provide relatively large query results over upwards of millions and even billions of records. In some instances, queries resulting in such relatively large query results can be executed at relatively high frequencies, which produces large workloads for the database system.

In further detail, query execution can include parsing using a parser, optimizing using an optimizer, and executing using an execution engine, each of which can be provided as one or more computer-executable programs. In some examples, the parser parses the query to define a data structure that enables further processing. In some examples, the data structure includes a query parse (QP) tree (also referred to as a query tree, a parse tree, or an abstract syntax tree (AST)), which can be described as a tree representation of the abstract syntactic structure of the query written in a query language (e.g., SQL). The query tree includes nodes, each node representing a clause (e.g., SELECT clause, FROM clause) of the query.

In some examples, the QP tree is normalized, which includes determining column and table names, transforming the QP tree into a conjugate normal form (CNF), and resolving datatypes. In some examples, a preprocessor transforms the QP tree for some types of query statements, such as query statements with sub-queries and views, to a more efficient QP tree. In some examples, an optimizer analyzes possible combinations of operations (e.g., join ordering, access and join methods, parallelism) to execute query statements and select a combination of operations that is determined to be most efficient in terms of cost estimates of the alternatives (e.g., cost in terms of time to execute, cost in terms of technical resources consumed to execute). In some examples, a code generator converts the QP tree generated by the parser into query compilation (QC) tree, which is a format that is suitable for optimization. In some examples, the optimizer can execute optimization, during which the QC tree is converted to a query optimization (QO) tree, rewrite the QO tree, and determine specific algorithm for each QO node.

To provide further context, a QP tree can be referred to as an abstract syntax tree (AST), while the QC tree is a relational algebra tree. Unlike an AST, a relational algebra tree can depict the execution sequence of a query statement, progressing from leaf nodes upward to a root node. The QP tree is instrumental in constructing the QO tree. By way of non-limiting example, when a SQL query is execute, the database management system first parses the query, checking for syntax errors. The result of this parsing is a QP tree, which is an intermediate step towards executing the SQL query. This QP tree is then converted into an AST which represents the structure of the SQL statement. An example QP tree can include a root node of sub-query, intermediate nodes of SELECT clause, FROM clause, and WHERE clause with respective lead nodes of SUM (a), table T1, and a=1.

Continuing, the QC tree can be described as transition tree between the QP tree and the QO tree. During query compilation, the QP is converted to a QC tree and then converted to initial QO tree. An example initial QO tree can include a root node of SELECT a, sub[b], intermediate nodes of ORDER BY a, GROUP BY a, and WHERE a +1, and a root node of V1. The QC tree represents an intermediate state in query processing. Both the QC tree and the QO tree are forms of relational algebra trees. However, the nodes of the QO tree contain more detailed information than the nodes of the QC tree. For example, in the case of a table node, both the nodes of the QC tree and the nodes of the QO tree include the database name, schema name, and table name. The QO node, though, also specifies the table type, such as whether it is a row table or column table. The QC tree serves as a foundation for constructing the more detailed QO tree.

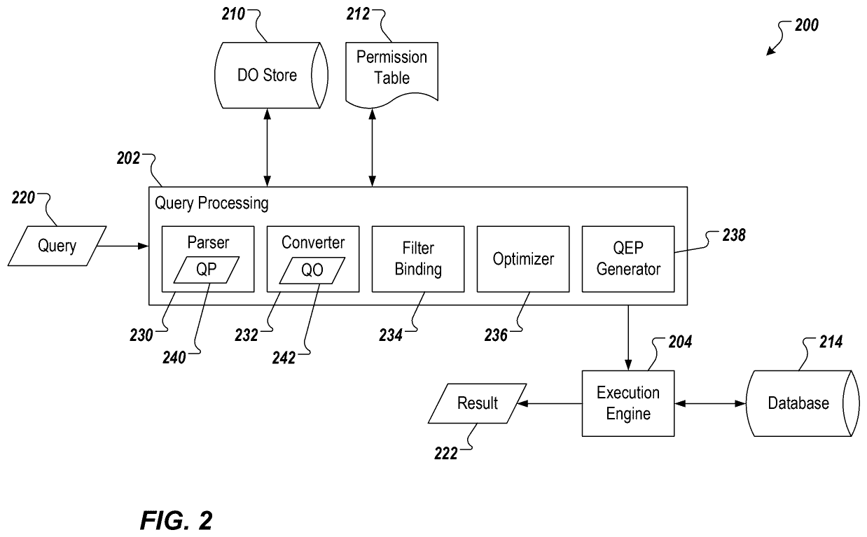

FIG. 2 depicts a conceptual architecture 200 for instituting row-level security in database systems in accordance with implementations of the present disclosure. In the example of FIG. 2, the conceptual architecture 200 includes a query processing system 202, an execution engine 204, a database object store 210, a permission table 212, and a database 214. In some examples, the query processing system 202 includes a parser module 230, a converter module 232, a filter binding module 234, an optimizer module 236, and a QEP generator 238.

As described in further detail herein, a query 220 is received and is processed by the query processing system 202 to generate a query execution plan (QEP) that is executed by the execution engine 204 to query one or more tables stored within the database 214 to generate a result 222. In some examples, the result 222 includes one or more views on data stored in the database 214. As described in further detail herein, row-level security is applied to at least one of the views of the result 222 in accordance with implementations of the present disclosure, such that data represented in the at least one view is limited (e.g., only includes data that a user that issued the query 220 is authorized to access).

In further detail, during a design-time (e.g., prior to receiving queries for application of row-level security), database objects that are to be protected by row-level security are generated and stored in the database object store 210. For each database object, a row-level security protection flag is saved in metadata of the database object. For example, the metadata can include a row-level security protection flag that can be assigned a first value (e.g., 0) indicating that the respective database object (e.g., view) does not have row-level security, or a second value (e.g., 1) indicating that the respective database object (e.g., view) does have row-level security. In some examples, the metadata also specify the condition provider procedure that is to be used to generate the filter string (e.g., the metadata includes “TEST_SCHEMA”. “P1”).

The following non-limiting example data schema and view (database object) can be considered:

Listing 1: Example Data Schema

create schema “TEST_SCHEMA”;
create column table “TEST_SCHEMA”.“T1” (“year_key” nvarchar(10), “year_sid” nvarchar(10),
“customer_sid” nvarchar(10), “sales” int);
insert into “TEST_SCHEMA”.“T1” values (‘2006’, ‘2006’, ‘CUSTOMER_A’, 1000);
insert into “TEST_SCHEMA”.“T1” values (‘2006’, ‘2006’, ‘CUSTOMER_B’, 3000);
insert into “TEST_SCHEMA”.“T1” values (‘2007’, ‘2007’, ‘CUSTOMER_A’, 1000);
insert into “TEST_SCHEMA”.“T1” values (‘2007’, ‘2007’, ‘CUSTOMER_B’, 2000);

Listing 2: Example View

--create a SQL view protected by row level security
CREATE VIEW “TEST_SCHEMA”.“V1” AS (SELECT * FROM “TEST_SCHEMA”.“T1”)
WITH STRUCTURED FILTER CHECK;

In the example of Listing 2, a view, with view name V1, on the data schema of Listing 1 is to have row-level security applied.

In some implementations, during the design-time, the permission table 212 is defined. In some examples, the permission table 212 records filters, schema names, and view names. For example:

Listing 3: Example Portion of Permission Table

--create permission table
CREATE COLUMN TABLE “TEST_SCHEMA”.“PT” (“filterString” varchar(5000),
“schemaName” varchar(256), “viewName” varchar(256));
INSERT INTO “TEST_SCHEMA”.“PT” VALUES(‘“year_key” = “2006”’, ‘TEST_SCHEMA’,
‘V1’);
INSERT INTO “TEST_SCHEMA”.“PT” VALUES(‘“year_key” = “2007”’, ‘TEST_SCHEMA’,
‘V2’);

Using the example of Listing 3, the permission table 212 corresponds to the data schema of Listing 1 and indicates that a filter (“year_key”=“2006”) is to be applied to the view (‘V1’) on the data schema (′TEST_SCHEMA′), and that a filter (“year_key”=“2007”) is to be applied to a view (‘V2’) on the data schema (′TEST_SCHEMA′).

In some implementations, during design-time, row-level security is defined on protected database objects (e.g., views) in order to manage binding between the database objects and a condition provider procedure. An example condition provider procedure can be provided as:

Listing 4: Example Condition Provider Procedure

```
--create condition provider procedure
CREATE PROCEDURE “TEST_SCHEMA”.“P1” (OUT VAL VARCHAR(5000),
  IN SCHEMA_NAME VARCHAR(5000) DEFAULT,
  IN OBJECT_NAME VARCHAR(5000))
  LANGUAGE SQLSCRIPT SQL SECURITY DEFINER READS SQL DATA AS
  BEGIN
    DECLARE v_Val VARCHAR(5000);
    DECLARE CURSOR c_GetOneOperand FOR
    SELECT “filterString” FROM “TEST_SCHEMA”.“PT” WHERE “schemaName” =
:SCHEMA_NAME and “objectName” = : OBJECT_NAME;
    OPEN c_GetOneOperand;
    FETCH c_GetOneOperand INTO v_Val;
    IF c_GetOneOperand::NOTFOUND THEN
      VAL = NULL;
    ELSE
      VAL = v_Val;
    END IF;
    CLOSE c_GetOneOperand;
  END;
```

An example filter binding for row-level security can be provided as:

Listing 5: Example Filter Binding

--create row level security to bind protected database object and condition provider
procedure
CREATE STRUCTURED FILTER “SF” FOR SELECT ON “TEST_SCHEMA”.”V1”
CONDITION PROVIDER “TEST_SCHEMA”.”P1”;

In the examples of Listings 4 and 5, the example condition provider procedure identified in the metadata for a view node is “TEST_SCHEMA”. “P1” and example input parameters of the condition provider procedure are SCHEMA NAME and OBJECT_NAME.

In some implementations, a condition provider procedure can be absent input parameters of SCHEMA NAME and OBJECT_NAME. The following non-limiting example can be considered:

Listing 6: Example Condition Provider Procedure

```
CREATE PROCEDURE
“USER0SFQUERY”.“PROC_FOR_DYNAMIC_SQL_SF_SQLSF_FOR_SQL_VIEW” (OUT
VAL VARCHAR(5000))
  LANGUAGE SQLSCRIPT SQL SECURITY DEFINER READS SQL DATA AS
  BEGIN
    DECLARE v_Val VARCHAR(5000);
    DECLARE CURSOR c_GetOneOperand FOR
    SELECT “filter_string” FROM
“USER0SFQUERY”.“TABLE_FOR_DYNAMIC_SQL_SF_SQLSF_FOR_SQL_VIEW”
WHERE “userName” = SESSION_USER;
    OPEN c_GetOneOperand;
    FETCH c_GetOneOperand INTO v_Val;
    IF c_GetOneOperand::NOTFOUND THEN
      VAL = NULL;
    ELSE
      VAL = v_Val;
    END IF;
    CLOSE c_GetOneOperand;
  END;
```

In the example of Listing 6, the condition provider procedure is absent input parameters of SCHEMA NAME and OBJECT_NAME, and results in a filter string being generated based on the user that submitted the query (e.g., a role of the user as determined using SESSION_USER). In some examples, and as described in further detail herein, the filter string includes a filter predicate (e.g., a WHERE clause) that filters data from being retrieved.

In some implementations, during runtime, queries are received and are processed to generate query results. For example, the query 220 is received by the query processing system 202 and is processed to provide the result 222. As described in further detail herein, when a database object is queried, the schema and name of the database object are selectively passed into a condition provider procedure (e.g., “TEST_SCHEMA”. “P1” of Listing 4). A filter string is generated, is converted into a QO predicate, and is injected into a QEP that is executed to provide a result (e.g., the result 222).

For purposes of non-limiting illustration, an example query statement that can be included in the query 220 can be considered and provided as:

Listing 7: Example Query Statement

SELECT “year_key”, “sales” FROM “TEST_SCHEMA”.“V1”

In response to receiving the query 220, the query 220 is parsed to provide a QP tree 240, which is preprocessed (e.g., by a preprocessor) to transform the QP tree 240 for some types of query statements, such as query statements with sub-queries and views, to improve efficiency of the QP tree 240. In some examples, a semantics check is performed (e.g., by a semantics checker) to ensure that the QP tree 240 is semantically correct. The semantics check can generally be described as determining whether query statements are meaningful in terms of what is being requested from the database system. That is, for example, whether the data objects (e.g., tables, columns, views, procedures) in the statement actually exist within the database system. If the semantics check passes, the converter 232 converts the QP tree 240 to a QC tree and converts the QC tree to an initial QO tree 242.

In accordance with implementations of the present disclosure, the initial QO tree 242 is traversed (e.g., by the filter binding module 234) to define a set of view nodes (e.g., [n_{view1}, . . . , n_{viewm}]) that are to have row-level security applied. Here, a view node is a node of the initial QO tree 242 that represents a view (e.g., V1, V2) on data. In some examples, whether a view is to have row-level security applied is determined by checking the row-level security protection flag of the metadata of the respective view. In some implementations, for each view node (e.g., n_{viewi}), a respective condition provider procedure is retrieved (e.g., from the metadata) and it is determined whether the condition provider procedure has input parameters of schema name and object name (e.g., see the example of Listing 4). If the condition provider procedure has input parameters of schema name and object name, the schema name and the object name of the view node (e.g., n_{viewi}) are input to the condition provider procedure, which generates a filter string from the permission table 212. The filter string is converted to a QO predicate, which is injected into the view node in the initial QO tree 242 to be included as part of a final QO tree.

By way of non-limiting example, in response to the query statement of Listing 6, a filter predicate “year_key”=‘2006’ for the view “TEST_SCHEMA”. “V1” is retrieved from the permission table and is converted to a QO predicate. For example, a query statement is modified to add the filter string. Continuing with the non-limiting examples above, if the filter string is “year_key”=“2006”, the query statement is provided as:

Listing 8: Example Modified Query Statement

SELECT * FROM “TEST_SCHEMA”.“V1” WHERE “year_key” =
‘2006’

In some examples, the query statement is compiled to provide a simple QO tree (e.g., a QO tree for the modified query statement), the QO predicate is copied from the simple QO tree, and is inserted into the initial QO tree 242, ultimately being included in the final QO tree. In view of the non-limiting examples above, an example portion of a final QO tree can be provided as:

Listing 9: Example Portion of Final QO Tree

# ROOT (opId:L:14) (engId:L:14) result_size:−1 rel_addr:0x00007efa576b14c0
# PROJECT (opId:L:15) (engId:L:15) ((0, 0), (0, 2)) result_size:−1
rel_addr:0x00007efa576b1580
# TABLE T1 (0) (opId:L:16) (engId:L:16) from
VIEW(TEST_SCHEMA.V1) FILTER: (0, 0) = ‘2006’ TABLE used cols:: 0, 2,
1000001 TABLE histo cols:: 0, 1000001 TABLE key joined cols:: input_size:−1
table_location: ccde1gl1717:30003|0 result_size:−1 rel_addr:0x00007efa576b19a0

In the example of Listing 9, application of row-level security results in a QO node TABLE T1 having a filter (FILTER: (0, 0)=‘2006’) being added to the final QO tree.

If the condition provider procedure for the view node does not include input parameters of schema name and object name (e.g., see the example of Listing 6), the condition provider procedure generates a filter string based on the user (e.g., role of the user). The filter string is converted to a QO predicate, which is injected into the view node in the initial QO tree 242 to be included as part of a final QO tree. In rewriting the QO tree, one relational algebra tree is converted into another, while preserving its semantics. This transformation involves normalizing or simplifying the structure of the source algebra tree to produce a target tree. Additionally, specific algorithms are assigned to the nodes within the QO tree. For example, when dealing with a JOIN node, a hash join algorithm can be selected from various available options to optimize the execution.

In some implementations, the QEP generator 238 processes the final QO tree to generate a QEP. The QEP is processed by the execution engine 204, which queries the database 214 to retrieve data responsive to the query 220, the data being filtered based on the filter strings that had been added to the initial QO tree to provide the final QO tree. During query processing, the database generates a QEP by converting operations in the physical plan (final QO tree) into specific execution operators, arranging the execution order to ensure correct handling of data dependencies, allocating appropriate memory and CPU resources, managing temporary storage and data transmission, and making adjustments to improve execution efficiency. These steps help the database create an effective QEP to efficiently execute the query and return results.

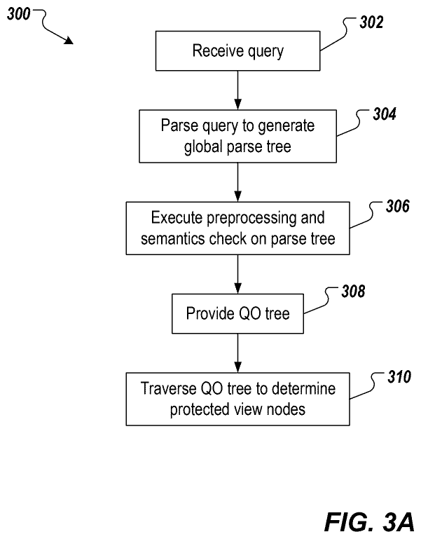

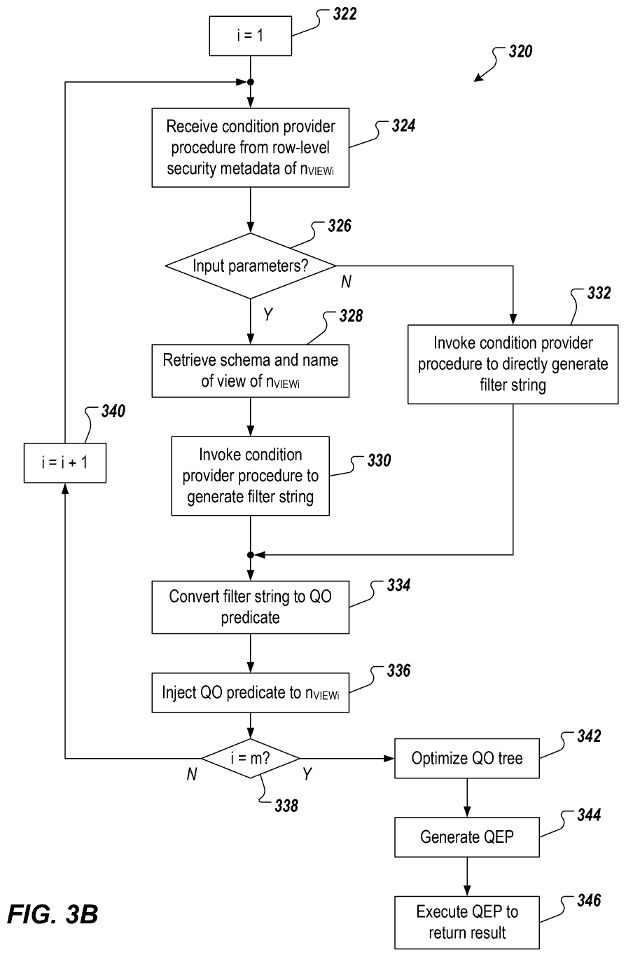

FIG. 3A depicts an example process 300 that can be executed in accordance with implementations of the present disclosure. In some examples, the example process 300 is provided using one or more computer-executable programs executed by one or more computing devices.

A query is received (302). For example, and as described in detail herein with reference to FIG. 2, the query 220 can be received by the query processing system 202 from a user (e.g., the user 112 of FIG. 1). The query is parsed to generate a QP tree (304), and preprocessing and a semantics check are executed on the QP tree (306). For example, and as described in detail herein, the query 220 is parsed to provide the QP tree 240, which is preprocessed (e.g., by a preprocessor) to transform the QP tree 240 for some types of query statements, such as query statements with sub-queries and views, to improve efficiency of the QP tree 240. In some examples, a semantics check is performed (e.g., by a semantics checker) to ensure that the QP tree 240 is semantically correct. An initial QO tree is provided (308). For example, and as described in detail herein, if the semantics check passes, the QP tree 240 is converted to a QC tree, and the QC tree is converted to an initial QO tree 242 (e.g., by the converter 232). The QO tree is traversed to determine a set of protected view nodes (310). For example, and as described in detail herein, the filter binding module traverses the initial QO tree to identify view nodes in the initial QO tree and, for each view node, determine whether row-level security is to be applied to the view node. If row-level security is to be applied to a view node, the view node is provided to a set of view nodes [n_{view1}, . . . , n_{viewm}]. In some examples, the set of view nodes [n_{view1}, . . . , n_{viewm}] is a sub-set of a superset of view nodes included in the initial QO tree (e.g., the set of view nodes includes m view nodes, the initial QO tree includes q view nodes, where m<q).

FIG. 3B depicts an example process 320 that can be executed in accordance with implementations of the present disclosure. In some examples, the example process 320 is provided using one or more computer-executable programs executed by one or more computing devices.

A counter i is set equal to 1 (322), and a condition provider procedure is determined from row-level security metadata of n_{viewi} (324). For example, and as described in detail herein, metadata of n_{viewi} can indicate a condition provider procedure that is to be applied to n_{viewi} to selectively filter data from being surface in a view represented by n_{viewi}. It is determined whether specific input parameters are provided (326). For example, and as described in detail herein, a set of input parameters for the condition provider is referenced to determine whether the set of input parameters includes schema name and object name. If input parameters are provided, the schema and view name of the view of n_{viewi} are retrieved (328) and the condition provider procedure is invoked to generate a filter string (330). For example, and as described in detail herein, the schema name and the object name of the view node (e.g., n_{viewi}) are input to the condition provider procedure, which generates a filter string from the permission table 212. The filter string is converted to a QO predicate, which is injected into the view node in the initial QO tree 242 to be included as part of a final QO tree. If the specific input parameters are not provided, the condition provider procedure is invoked to directly generate a filter string (332). For example, and as described in detail herein, the condition provider procedure generates a filter string based on the user (e.g., role of the user).

The filter string is converted to a QO predicate (332) and the QO predicate is injected into n_{viewi} (336). For example, and as described in detail herein, a modified query statement (e.g., a query statement with a filter predicate added thereto) is compiled to provide a simple QO tree (e.g., a QO tree for the modified query statement), the QO predicate is copied from the simple QO tree, and is inserted into the initial QO tree 242, ultimately being included in the final QO tree.

It is determined whether i is equal to m (338). If i is not equal to m, the counter i is incremented (340) and the example process 320 loop back. If i is equal to m, the QO tree is optimized (342), a QEP is generated (344), and the QEP is executed to return a result (346).

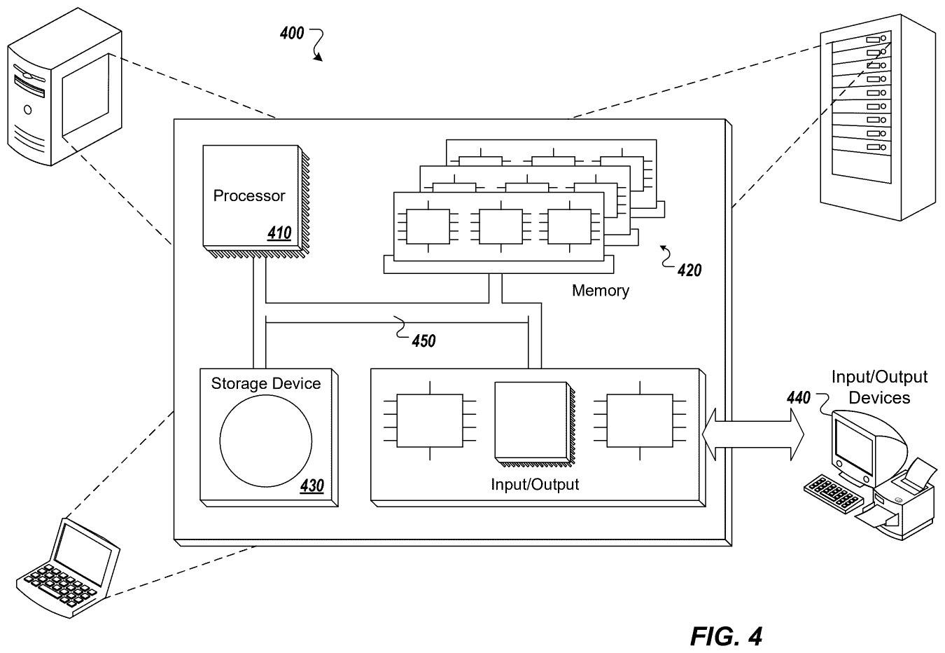

Referring now to FIG. 4, a schematic diagram of an example computing system 400 is provided. The system 400 can be used for the operations described in association with the implementations described herein. For example, the system 400 may be included in any or all of the server components discussed herein. The system 400 includes a processor 410, a memory 420, a storage device 430, and an input/output device 440. The components 410, 420, 430, 440 are interconnected using a system bus 450. The processor 410 is capable of processing instructions for execution within the system 400. In some implementations, the processor 410 is a single-threaded processor. In some implementations, the processor 410 is a multi-threaded processor. The processor 410 is capable of processing instructions stored in the memory 420 or on the storage device 430 to display graphical information for a user interface on the input/output device 440.

The memory 420 stores information within the system 400. In some implementations, the memory 420 is a computer-readable medium. In some implementations, the memory 420 is a volatile memory unit. In some implementations, the memory 420 is a non-volatile memory unit. The storage device 430 is capable of providing mass storage for the system 400. In some implementations, the storage device 430 is a computer-readable medium. In some implementations, the storage device 430 may be a floppy disk device, a hard disk device, an optical disk device, or a tape device. The input/output device 440 provides input/output operations for the system 400. In some implementations, the input/output device 440 includes a keyboard and/or pointing device. In some implementations, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for row-level security in database systems, the method being executed by one or more processors and comprising:
providing an initial query tree responsive to a query for querying a database system, the initial query tree comprising a set of view nodes;
determining a sub-set of view nodes from the set of view nodes, each view node in the sub-set of view nodes being included in the sub-set of view nodes in response to metadata indicating that row-level security is to be applied;
for a first view node in the sub-set of view nodes:
identifying a first condition provider procedure that is to be executed,
determining that the first condition provider procedure comprises a first set of input parameters comprising predefined input parameters, and in response:
executing the first condition provider procedure using values for the first set of input parameters provided for the first view node to provide a first filter string, and
inserting the first filter string into the initial query tree;
providing a final query tree comprising the initial query tree and inserted filter strings;
generating a query execution plan;
executing, by an execution engine, the query execution plan to query a database and generate results responsive to the query; and
returning the results.

2. The method of claim 1, wherein the first filter string is determined by the first condition provider procedure from a permission table.

3. The method of claim 2, wherein the permission table defines a set of filter strings that are to be applied to respective views of view nodes.

4. The method of claim 1, wherein providing a final query tree comprising the initial query tree and inserted filter strings comprises converting the first filter string to a filter predicate and injecting the filter predicate into the initial query tree.

5. The method of claim 4, wherein the filter predicate comprises a WHERE predicate.

6. The method of claim 1, wherein the predefined input parameters comprise a schema name and an object name.

7. The method of claim 1, further comprising:
for a second view node in the sub-set of view nodes:
identifying a second condition provider procedure that is to be executed,
determining that the second condition provider procedure comprises a second set of input parameters that is absent the predefined input parameters, and in response:
executing the second condition provider procedure to provide a second filter string based on an identifier of a user that submitted the query, and
inserting the second filter string into the initial query tree.

8. A non-transitory computer-readable storage medium coupled to one or more processors and having instructions stored thereon which, when executed by the one or more processors, cause the one or more processors to perform operations for row-level security in database systems, the operations comprising:
providing an initial query tree responsive to a query for querying a database system, the initial query tree comprising a set of view nodes;
determining a sub-set of view nodes from the set of view nodes, each view node in the sub-set of view nodes being included in the sub-set of view nodes in response to metadata indicating that row-level security is to be applied;
for a first view node in the sub-set of view nodes:
identifying a first condition provider procedure that is to be executed,
determining that the first condition provider procedure comprises a first set of input parameters comprising predefined input parameters, and in response:
executing the first condition provider procedure using values for the first set of input parameters provided for the first view node to provide a first filter string, and
inserting the first filter string into the initial query tree;
providing a final query tree comprising the initial query tree and inserted filter strings;
generating a query execution plan;
executing, by an execution engine, the query execution plan to query a database and generate results responsive to the query; and
returning the results.

9. The non-transitory computer-readable storage medium of claim 8, wherein the first filter string is determined by the first condition provider procedure from a permission table.

10. The non-transitory computer-readable storage medium of claim 9, wherein the permission table defines a set of filter strings that are to be applied to respective views of view nodes.

11. The non-transitory computer-readable storage medium of claim 8, wherein providing a final query tree comprising the initial query tree and inserted filter strings comprises converting the first filter string to a filter predicate and injecting the filter predicate into the initial query tree.

12. The non-transitory computer-readable storage medium of claim 11, wherein the filter predicate comprises a WHERE predicate.

13. The non-transitory computer-readable storage medium of claim 8, wherein the predefined input parameters comprise a schema name and an object name.

14. The non-transitory computer-readable storage medium of claim 8, wherein operations further comprise:
for a second view node in the sub-set of view nodes:
identifying a second condition provider procedure that is to be executed,
determining that the second condition provider procedure comprises a second set of input parameters that is absent the predefined input parameters, and in response:
executing the second condition provider procedure to provide a second filter string based on an identifier of a user that submitted the query, and
inserting the second filter string into the initial query tree.

15. A system, comprising:
a computing device; and
a computer-readable storage device coupled to the computing device and having instructions stored thereon which, when executed by the computing device, cause the computing device to perform operations for row-level security in database systems, the operations comprising:
providing an initial query tree responsive to a query for querying a database system, the initial query tree comprising a set of view nodes;
determining a sub-set of view nodes from the set of view nodes, each view node in the sub-set of view nodes being included in the sub-set of view nodes in response to metadata indicating that row-level security is to be applied;
for a first view node in the sub-set of view nodes:
identifying a first condition provider procedure that is to be executed,
determining that the first condition provider procedure comprises a first set of input parameters comprising predefined input parameters, and in response:
executing the first condition provider procedure using values for the first set of input parameters provided for the first view node to provide a first filter string, and
inserting the first filter string into the initial query tree;
providing a final query tree comprising the initial query tree and inserted filter strings;
generating a query execution plan;
executing, by an execution engine, the query execution plan to query a database and generate results responsive to the query; and
returning the results.

16. The system of claim 15, wherein the first filter string is determined by the first condition provider procedure from a permission table.

17. The system of claim 16, wherein the permission table defines a set of filter strings that are to be applied to respective views of view nodes.

18. The system of claim 15, wherein providing a final query tree comprising the initial query tree and inserted filter strings comprises converting the first filter string to a filter predicate and injecting the filter predicate into the initial query tree.

19. The system of claim 18, wherein the filter predicate comprises a WHERE predicate.

20. The system of claim 15, wherein the predefined input parameters comprise a schema name and an object name.
